(19) United States
(12) Patent Application Publication
(10) Pub. No.: US 2026/0205564 A1
(43) Pub. Date: Jul. 16, 2026

(54) FRAME BUFFER COMPRESSOR, AND IMAGE PROCESSING DEVICE HAVING THE SAME

(71) Applicant: Samsung Electronics Co., Ltd., Suwon-si (KR)

(72) Inventors: Sungho JUN, Suwon-si (KR); Jungyeop YANG, Suwon-si (KR)

(73) Assignee: Samsung Electronics Co., Ltd., Suwon-si (KR)

(21) Appl. No.: 19/269,239

(22) Filed: Jul. 15, 2025

(30) Foreign Application Priority Data
Jan. 13, 2025 (KR) 10-2025-0004824

(51) Int. Cl. H04N 9/64; G06T 7/70

(52) U.S. Cl. CPC H04N 9/646; G06T 7/70

(57) ABSTRACT

An image processing device includes a multimedia Intellectual Property configured to process image data and generate source data, and a frame buffer compressor configured to compress the source data, generate compressed data, decompress the compressed data and generate output data. The frame buffer compressor configured to generate quantized data by performing quantization on the source data using a plurality of pixel position offsets corresponding to each of coordinates of a plurality of image pixels included in the source data, and a quantization coefficient, and generate the compressed data by processing the quantized data.

### CROSS-REFERENCE TO RELATED APPLICATION(S)

This application claims the benefit under 35 USC 119(a) of Korean Patent Application No. 10-2025-0004824 filed on Jan. 13, 2025 in the Korean Intellectual Property Office, the entire disclosure of which is incorporated herein by reference for all purposes.

### BACKGROUND

The present inventive concepts relate to frame buffer compressors and/or image processing devices including the same.

As desire for high-definition and high-resolution images increases, the amount of memory accessed by various multimedia Intellectual Properties (TPs) of image processing devices, for example, a bandwidth of information to be shared, may increase significantly. As bandwidth increases, the processing capability of image processing devices may reach limits thereof, causing problems such as slowing processing speeds for high-definition and high-resolution images. Accordingly, methods of compressing the size of data when multimedia TPs access memory are being considered. For example, data may be compressed before writing data to memory, and compressed data may be decompressed before reading data from memory.

Recently, the dynamic range compression gain (DRC gain) has been gradually increasing to improve image quality in dark areas. As the dynamic range compression gain increases, small errors may be repeated and/or compounded, causing problems such as color distortion. In detail, errors occurring during data compression and decompression may deteriorate the color and quality of images.

### SUMMARY

Some example embodiments provide frame buffer compressors and image processing devices including the same, in which errors occurring in data compression and decompression processes are not biased in a specific direction by calculating a pixel position offset corresponding to coordinates of each of a plurality of image pixels included in source data and applying the pixel position offset to a process of quantizing the source data.

According to some example embodiments, an image processing device includes a multimedia Intellectual Property configured to process image data and generate source data, and a frame buffer compressor configured to compress the source data, generate compressed data, decompress the compressed data, and generate output data. The frame buffer compressor is further configured to generate quantized data by performing quantization on the source data using a plurality of pixel position offsets corresponding to each of coordinates of a plurality of image pixels included in the source data, and a quantization coefficient, and generate the compressed data by processing the quantized data.

According to some example embodiments, a frame buffer compressor includes an encoder configured to compress source data and generate compressed data, and a decoder configured to decompress the compressed data and generate output data. The encoder is configured to generate quantized data by performing quantization on the source data using pixel position offsets obtained by modulo operating each of coordinates of a plurality of image pixels included in the source data, and a quantization coefficient, and generate the compressed data by processing the quantized data.

According to some example embodiments, a data processing method includes receiving source data from a multimedia IP, calculating a first offset determined by each of coordinates of a plurality of image pixels included in the source data by a frame buffer compressor, determining a second offset determined by a coefficient and ½ of the coefficient by the frame buffer compressor, and performing, by the frame buffer compressor, an operation of obtaining a result of subtracting the first offset from the source data and adding the second offset and dividing the obtained result by the coefficient.

According to some example embodiments, an image processing device includes a multimedia Intellectual Property configured to process image data and generate source data, and a frame buffer compressor including an encoder including a first mode selector, a quantization module, a prediction module, an entropy encoding module, and a padding module, the first mode selector configured to select a first data path or a second data path, the first data path including each of the quantization module, the prediction module, the entropy encoding module, and the padding module, the second data path including each of the prediction module, the entropy encoding module, and the padding module, bypassing the quantization module. The quantization module configured to generate quantized data by performing quantization on the source data using a plurality of pixel position offsets corresponding to each of coordinates of a plurality of image pixels included in the source data, and a quantization coefficient, and generate the compressed data by processing the quantized data.

According to some example embodiments, the frame buffer compressor of the image processing device may further include a decoder including a second mode selector, an unpadding module, a decompression manager, an entropy decoding module, a prediction compensation module, and an inverse quantization module.

### BRIEF DESCRIPTION OF DRAWINGS

The above and other aspects, features, and advantages of the present inventive concepts will be more clearly understood from the following detailed description, taken in conjunction with the accompanying drawings, in which:

FIG. 1 is a block diagram illustrating an image processing device according to some example embodiments;

FIG. 2 is a block diagram illustrating a frame buffer compressor according to some example embodiments;

FIG. 3 is a block diagram illustrating an encoder according to some example embodiments;

FIG. 4 is a block diagram illustrating a decoder according to some example embodiments;

FIG. 5 is a diagram illustrating a pixel array included in a sensor according to some example embodiments;

FIG. 6 is a diagram illustrating image data generated by an image sensor according to some example embodiments;

FIG. 7 is a diagram illustrating source data according to some example embodiments;

FIG. 8 is a diagram illustrating quantized data according to some example embodiments;

FIG. 9 is a diagram illustrating output data according to some example embodiments;

FIG. 10 is a diagram illustrating error data according to some example embodiments;

FIG. 11 is a block diagram illustrating an image processing device according to some example embodiments;

FIG. 12 is a block diagram illustrating an image processing device according to some example embodiments; and

FIG. 13 is a block diagram illustrating an image processing device according to some example embodiments.

### DETAILED DESCRIPTION

Hereinafter, some example embodiments will be described with reference to the accompanying drawings.

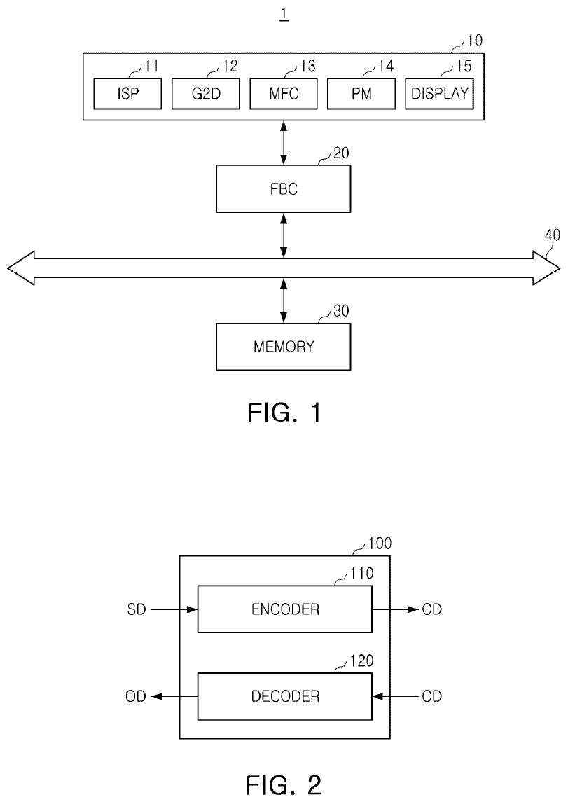

FIG. 1 is a block diagram illustrating an image processing device according to some example embodiments.

Referring to FIG. 1, an image processing device 1 may include a multimedia Intellectual Property (IP) 10, a frame buffer compressor 20, a memory 30, and a system bus 40.

The multimedia IP 10 may be a part that directly performs processing of images and the like of the image processing device 1. The multimedia IP 10 may include a plurality of modules related to processing of images and videos. For example, the multimedia IP 10 may process image processing, image capture, and/or image output. For another example, the multimedia IP 10 may process recording and playback of videos, such as camcoding and playback of video images. In detail, the multimedia IP 10 may include processing modules that should access the memory 30 to process videos or images.

The multimedia IP 10 may receive image data from a sensor (not illustrated). The sensor may be an image sensor that receives light and generates image data. The image data may be raw data of a video or an image. The image sensor may include a pixel array, and the pixel array may include a plurality of pixels arranged in a Bayer pattern. At this time, the color arrangement of the plurality of image pixels included in the image data may match the color arrangement of the plurality of pixels included in the pixel array. Therefore, the color arrangement of the plurality of image pixels included in the image data may be determined by the color arrangement of the plurality of pixels included in the pixel array.

The multimedia IP 10 may process the image data and convert the image data into source data. The source data is data generated by the multimedia IP 10 and may also include data being processed by the multimedia IP 10. For example, the multimedia IP 10 may store the source data in the memory 30 through several steps and repeat the process of updating the data again. In detail, the source data may include all data to be output from the multimedia IP 10 and stored in the memory 30.

The source data may be stored in the memory 30 in the form of compressed data. The frame buffer compressor 20 may compress the source data to generate compressed data. The memory 30 may store the compressed data. The frame buffer compressor 20 may process the compressed data to generate recon data and decompress the recon data to generate output data. The frame buffer compressor 20 may output the output data to the multimedia IP 10. For example, the source data and the output data may be the same or different depending on the compression method.

The multimedia IP 10 may include an image signal processor (ISP) 11, a shake correction module (G2D) 12, a multi-format codec (MFC) 13, a processing module (PD) 14, and a display 15.

The image signal processor 11 may preprocess image data and convert the preprocessed data into source data. The image data may be raw data following the Bayer pattern. In some example embodiments, the image signal processor 11 may convert the image data into RGB format data, and convert the RGB format data into YUV format source data.

The RGB format may correspond to a data format that expresses colors based on the three primary colors of light. In detail, the RGB format may correspond to a method of expressing an image using the colors of red (RED), green (GREEN), and blue (BLUE).

The YUV format may correspond to a data format that expresses a luminance (luma) signal and a chrominance (chroma) signal separately. Y may refer to a luminance signal, and U (Cb) and V (Cr) may refer to chrominance signals, respectively. U may refer to the difference between the luminance signal and the blue signal component, and V may refer to the difference between the luminance signal and the red signal component. In this case, the items of Y, U(Cb) and V(Cr) may be defined as planes. For example, data for a luminance signal may be referred to as data of the Y plane, and data for a chrominance signal may be referred to as data of the U(Cb) plane or data of the V(Cr) plane.

For example, data in the YUV format may be converted from data in the RGB format by conversion formulas such as Y=0.3R+0.59G+0.11Bch, U=(B−Y)×0.493, V=(R−Y)×0.877 or the like. Since the human eye is more sensitive to luminance signals than color signals, data in the YUV format may be more easily compressed than data in the RGB format. Therefore, the image signal processor 11 may convert the image data into source data in the YUV format. The image signal processor 11 may store the converted source data in the memory 30.

The shake correction module 12 may perform shake correction of image or video data. Shake correction may include detecting and removing camera shake from the image or video data. The shake correction module 12 may perform shake correction by reading the image data or the output data decompressed from the frame buffer compressor 20. The shake correction module 12 may correct shake of the image data, source data, and/or output data to generate or update new source data and store the same in the memory 30.

The multi-format codec 13 may be a codec compressing video data. The multi-format codec 13 may compress video data by utilizing the correlation between multiple frames. The multi-format codec 13 may compress image data, source data, and/or output data from the memory 30. The multi-format codec 13 may compress the image data, source data, and/or output data to generate or update new source data, and store the data in the memory 30.

The processing module 14 may be a system unit including a plurality of units performing various processing tasks such as processing images and videos. The processing module 14 may include an image processing unit, a video processing unit, a display processing unit, a graphic processing unit, and/or a neural processing unit. The processing module 14 may generate or update source data from image data.

The image processing unit may perform various image processing tasks such as image resolution enhancement, color correction, filtering, and edge detection to improve image quality. The video processing unit processes video-related tasks such as decoding, encoding, compressing, and/or decoding video signals, and may optimize (for example, improve) video quality and process video data in real time. The display processing unit may process data to be ultimately displayed on the screen to control and optimize (for example, improve) the resolution, color, brightness, and the like of the image output on the screen.

The graphics processing unit is a unit that specializes in processing calculations related to graphics, and may perform 3D rendering, texture mapping, game graphics processing, UI graphics processing, or the like. The graphics processing unit may significantly increase graphics performance by utilizing high-speed parallel processing capabilities. The neural network processing unit may efficiently (e.g., with lower processing times, lower processing resources, and/or faster processing)process artificial intelligence (AI) and machine learning (ML) algorithms. The neural network processing unit may perform AI-based tasks such as image recognition, voice recognition, or natural language processing.

The display 15 may display output data from the memory 30 on the screen. In addition, the display 15 may display the source data processed by the image signal processor 11, the shake correction module 12, the multi-format codec 13, and/or the processing module 14 on the screen. However, the present disclosure may not be limited thereto.

The image signal processor 11, the shake correction module 12, the multi-format codec 13, the processing module 14, and the display 15 of the multimedia IP 10 may operate individually. In detail, each of the image signal processor 11, the shake correction module 12, the multi-format codec 13, the processing module 14, and the display 15 may individually access the memory 30 to write or read data. For example, the image signal processor 11, the shake correction module 12, the multi-format codec 13, the processing module 14, and the display 15 may individually access the memory 30 to write or read data in any order.

The frame buffer compressor 20 may compress source data to generate compressed data before the multimedia IP 10 individually accesses the memory 30. The frame buffer compressor 20 may decompress the compressed data to generate output data. The output data may be transmitted to the multimedia IP 10. In detail, the compressed data compressed by the frame buffer compressor 20 may be stored in the memory 30. The output data decompressed by the frame buffer compressor 20 may be loaded by the multimedia IP 10.

Whenever the image signal processor 11, the shake correction module 12, the multi-format codec 13, the processing module 14, and the display 15 of the multimedia IP 10 individually access the memory 30, the frame buffer compressor 20 may compress the source data into compressed data and transmit the compressed data to the memory 30. In addition, whenever there is a data request to the image signal processor 11, the shake correction module 12, the multi-format codec 13, the processing module 14, and the display 15 of the multimedia IP 10, the frame buffer compressor 20 may decompress the compressed data from the memory 30 into output data and transmit the data to each of the image signal processor 11, the shake correction module 12, the multi-format codec 13, the processing module 14, and the display 15 of the multimedia IP 10.

The memory 30 may store the compressed data generated by the frame buffer compressor 20. In addition, the memory 30 may provide the stored compressed data to the frame buffer compressor 20 so that the frame buffer compressor 20 may decompress it.

According to some example embodiments illustrated in FIG. 1, the system bus 40 may be connected to the frame buffer compressor 20 and the memory 30. In detail, the system bus 40 may be connected to each of the frame buffer compressor 20 and the memory 30. The multimedia IP 10 may be connected to the frame buffer compressor 20. For example, the multimedia IP 10 may be connected to the memory 30 through the frame buffer compressor 20 and the system bus 40.

The frame buffer compressor 20 may perform the task of converting source data into compressed data or compressed data into output data when each of the image signal processor 11, shake correction module 12, multi-format codec 13, processing module 14, and display 15 of the multimedia IP 10 accesses the memory.

In the compression process of a general frame buffer compressor, quantization may be performed by applying a half-rounding technique to the source data. In this process, source data that produces a decimal point 0.5 for a given quantization coefficient may be rounded off to generate quantized data. When decompressing compressed data, output data may be generated by reflecting the given quantization coefficient to the quantized data. At this time, the difference between the output data and the source data may be generated as error data.

By applying the half-rounding technique, the mean squared error (MSE) of multiple error data may be significantly reduced, and the peak signal-to-noise ratio (PSNR) may be improved. However, since source data that produces a decimal point 0.5 for the given quantization coefficient may be rounded off and is generated as quantized data, a problem may occur in which error data for multiple source data are biased in a specific direction.

The frame buffer compressor 20 according to some example embodiments may perform quantization on the source data by using a plurality of pixel position offsets corresponding to respective coordinates of a plurality of image pixels included in the source data, and a predetermined quantization coefficient to generate quantized data. The frame buffer compressor 20 may process the quantized data to generate compressed data. Although disclosed as a predetermined quantization coefficient, the quantization coefficient may be additionally and/or alternatively, generated, selected as a desired quantization coefficient.

According to some example embodiments, the plurality of pixel position offsets may be calculated as 0 or 1, and the predetermined quantization coefficient may be a positive even number. The frame buffer compressor 20 may generate quantized data by adding ½ of the quantization coefficient to the source data and subtracting the pixel position offset, and dividing the result by the quantization coefficient. Accordingly, error data may have a random tendency without being biased in a specific direction. In addition, the implementation of calculating the pixel position offset may be simplified.

FIG. 2 is a block diagram simply illustrating a frame buffer compressor according to some example embodiments.

Referring to FIG. 2, a frame buffer compressor 100 may include an encoder 110 and a decoder 120.

The encoder 110 may compress source data SD to generate compressed data CD. Referring to FIG. 1 and FIG. 2 together, the encoder 110 may compress source data SD from a multimedia IP 10 to generate compressed data CD. The compressed data CD may be transmitted to a memory 30 via a system bus 40.

The decoder 120 may decompress the compressed data CD stored in the memory 30 to generate output data OD. For example, the compressed data CD may be transmitted from the memory 30 to the frame buffer compressor 20. The compressed data CD transmitted to the frame buffer compressor 20 may be decompressed by the decoder 120.

The output data OD may be transmitted to the multimedia IP 10. At this time, the output data OD may be transmitted to each of the image signal processor 11, shake correction module 12, multi-format codec 13, processing module 14, and display 15 of the multimedia IP 10.

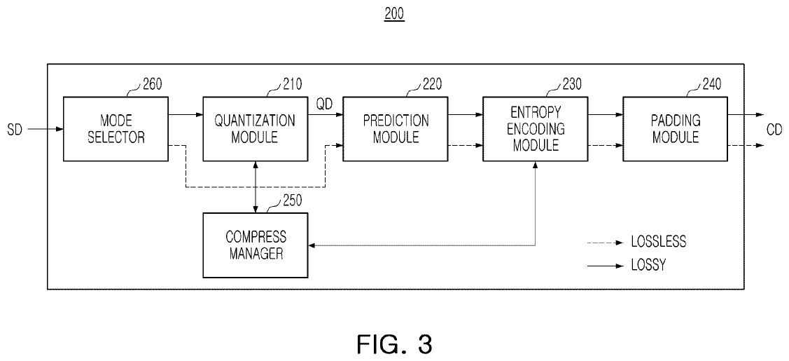

FIG. 3 is a block diagram simply illustrating an encoder according to some example embodiments.

The image processing device may include a multimedia IP, a frame buffer compressor, a memory, and a system bus. The frame buffer compressor may include an encoder and a decoder. Specific embodiments of the image processing device may be similar to those described above in FIGS. 1 and 2.

Referring to FIG. 3, the encoder 200 includes a first mode selector 260, a quantization module 210, a prediction module 220, an entropy encoding module 230, a padding module 240, and a compression manager 250.

The first mode selector 260 may determine whether the encoder 200 will operate in a lossless mode or a lossy mode. The first mode selector 260 may receive a signal from the multimedia IP that determines whether to perform lossless compression or lossy compression. In lossless compression, data may be compressed without loss, and the compression ratio may vary depending on the data. In lossy compression, some of the data may be compressed while being lost, and the compression ratio may be higher than that of lossless compression.

When the encoder 200 operates in a lossless mode, the source data may be compressed along the lossless path of some example embodiments illustrated in FIG. 3. The first mode selector 260 may induce data flow along the lossless path to the prediction module 220, the entropy encoding module 230, and the padding module 240. In this case, the first mode selector 260 may transfer the source data SD input to the encoder 200 to the prediction module 220.

When the encoder 200 operates in a lossy mode, the source data may be compressed along the lossy path of some example embodiments illustrated in FIG. 3. The first mode selector 260 may induce data flow along the loss path to the quantization module 210, the prediction module 220, the entropy encoding module 230, and the padding module 240. In this case, the first mode selector 260 may transfer the source data SD input to the encoder 200 to the quantization module 210. The quantization module 210 may perform quantization on the source data SD to generate quantized data QD and transfer the quantized data QD to the prediction module 220.

The prediction module 220 may perform intra-prediction on the source data SD or the quantized data QD to generate prediction data. The prediction module 220 may perform prediction on a pixel-by-pixel basis by utilizing the spatial correlation of the data. For example, the prediction module 220 may generate prediction data based on the statistical characteristics of surrounding data (for example, up, down, left, right pixel values). The prediction module 220 may generate residual data as the difference between the source data and the prediction data, and may reduce data redundancy to increase the efficiency of subsequent entropy encoding.

The entropy encoding module 230 may generate entropy data by performing entropy encoding on the prediction data. The entropy encoding module 230 may apply an entropy encoding algorithm, for example, of Huffman Coding, Arithmetic Coding, or Context-Adaptive Binary Arithmetic Coding (CABAC). The entropy encoding module 230 may express data with a minimum number of bits by assigning a short code to data with a high occurrence frequency and a long code to data with a low occurrence frequency. Accordingly, the storage space of the data may be reduced, and the transmission efficiency of the data may be improved.

The padding module 240 may perform padding on the entropy data to generate padding data. The padding module 240 may add meaningless data (for example, zero data) to the entropy data to generate padding data having a predefined size, or, alternatively, a desired or selected size. In some example embodiments, when the encoder 200 operates in a lossy mode, the size of the padding data may be defined based on the size of the source data and a fixed compression ratio. When the size of the source data is 100 and the fixed compression ratio is 50%, the size of the padding data may be defined as 50. In some example embodiments, when the encoder 200 operates in a lossless mode, the size of the padding data may be defined based on the size of the source data. When the size of the source data is 100, the size of the padding data may be defined as 100.

The quantization module 210 according to some example embodiments may perform quantization on the source data SD by using a plurality of pixel position offsets corresponding to respective coordinates of a plurality of image pixels included in the source data SD and a predetermined quantization coefficient to generate quantized data QD.

According to some example embodiments, the plurality of pixel position offsets may be calculated as 0 or 1, and the predetermined quantization coefficient may be a positive even number. The quantization module 210 may generate quantized data QD by adding ½ of the quantization coefficient to the source data SD and subtracting the pixel position offset, and dividing the result by the quantization coefficient.

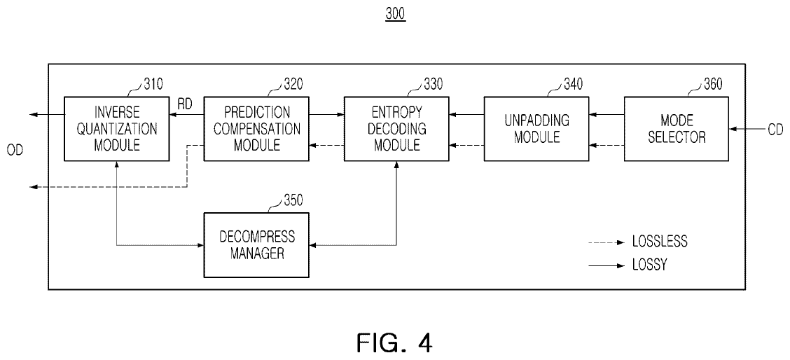

FIG. 4 is a block diagram illustrating a decoder according to some example embodiments.

The image processing device may include a multimedia IP, a frame buffer compressor, a memory, and a system bus as discussed in some example embodiments above. The frame buffer compressor may include an encoder and a decoder. Specific example embodiments of the image processing device may be similar to those described above in FIGS. 1 to 3.

Referring to FIG. 4, the decoder 300 includes a second mode selector 360, an unpadding module 340, a decompression manager 350, an entropy decoding module 330, a prediction compensation module 320, and an inverse quantization module 310.

The second mode selector 360 may determine whether compressed data CD stored in the memory is losslessly compressed or lossily compressed. For example, in the case of lossless mode, the second mode selector 360 may induce the compressed data CD along the lossless path. The compressed data CD may be inducible to the unpadding module 340, the entropy decoding module 330, and the prediction compensation module 320. In another example, in the case of lossy mode, the second mode selector 360 may induce compressed data CD along the lossy path. The compressed data CD may be inducible to the unpadding module 340, the entropy decoding module 330, the prediction compensation module 320, and the inverse quantization module 310.

The unpadding module 340 may remove meaningless data (for example, zero data) added by the padding module (240 of FIG. 3) of the encoder. For example, the unpadding module 340 may generate entropy data by removing zero data from the compressed data CD. The entropy data generated from the unpadding module 340 may be transferred to the entropy decoding module 330.

The entropy decoding module 330 may generate prediction data from the entropy data transferred from the unpadding module 340. The compressed data CD input to the decoder 300 includes a k value. The entropy decoding module 330 may perform entropy decoding using an entropy table identified from the k value. For example, the entropy decoding module 330 may generate residual data corresponding to the entropy data using the entropy table. The entropy decoding module 330 may generate prediction data using residual pixel data. The prediction data generated from the entropy decoding module 330 may be transferred to the prediction compensation module 320. The entropy decoding module 330 may perform decompression through Huffman coding, exponential Gollum coding, or Gollum Rice coding.

The prediction compensation module 320 may perform intra-prediction compensation on the prediction data to generate recon data RD or output data OD. The prediction compensation module 320 may decompress the prediction data by performing intra-prediction by the prediction module 220 of FIG. 4 in reverse order. If the compressed data CD is compressed in a lossy mode, the prediction compensation module 320 may generate recon data RD and transfer the data to the inverse quantization module 310. If the compressed data CD is compressed in a lossless mode, the prediction compensation module 320 may generate output data OD. In this case, the decoder 300 may transmit the output data OD to the multimedia IP.

The inverse quantization module 310 may generate the output data OD from the quantization coefficient from the compressed data CD and the recon data RD transmitted from the prediction compensation module 320. The inverse quantization module 310 may perform inverse quantization on the recon data using the quantization coefficient and generate the output data OD as a result. In some example embodiments, the output data may be generated by multiplying the recon data by the quantization coefficient. In some example embodiments, the output data may be generated by performing a bit shift operation on the recon data.

Referring to FIGS. 3 and 4 together, the inverse quantization module 310 may generate the output data OD from the recon data RD. At this time, the output data OD generated from the inverse quantization module 310 may be different from the source data SD input to the encoder 200. This is because when the quantization module 210 of the encoder 200 performs quantization on the source data SD, some of the source data SD may be lost and not restored. Therefore, the inverse quantization module 310 may be utilized only in the lossy mode.

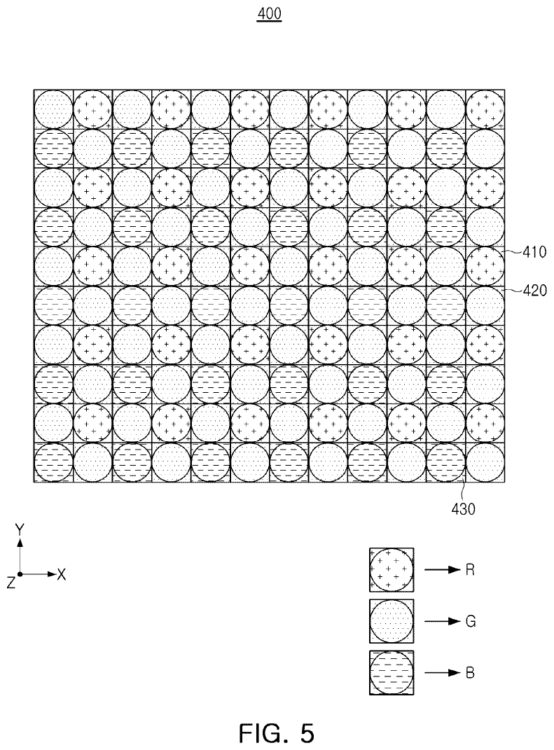

FIG. 5 is a diagram illustrating a pixel array included in a sensor according to some example embodiments.

Referring to FIG. 5, a pixel array 400 of an image sensor according to some example embodiments may include a plurality of pixel regions 410, 420 and 430 arranged along a first direction (X-axis direction) and a second direction (Y-axis direction). In the example embodiment illustrated in FIG. 5, color filters may be arranged along the plurality of pixel regions 410, 420 and 430. For example, the pixel array 400 may include red pixel regions 410, green pixel regions 420, and blue pixel regions 430. Each of the red pixel regions 410 may include a red color filter, each of the green pixel regions 420 may include a green color filter, and each of the blue pixel regions 430 may include a blue color filter.

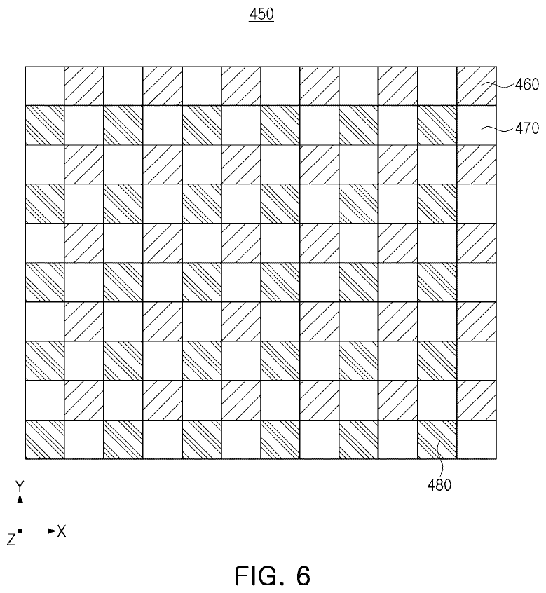

FIG. 6 is a diagram illustrating image data generated by an image sensor according to some example embodiments.

FIG. 6 may be an example of image data 450 generated by an image sensor, and the image data 450 may include a plurality of image pixels 460, 470 and 480. The plurality of image pixels 460, 470 and 480 may be arranged along the first direction and the second direction, similar to the pixel regions 410, 420 and 430 arranged in the pixel array 400 of FIG. 5.

In some example embodiments, the plurality of image pixels 460, 470 and 480 may correspond to the pixel regions 410, 420 and 430. Therefore, each of the plurality of image pixels 460, 470 and 480 may express one color among red, green, and blue, and the image data 450 may be generated in a Bayer data format. If the pixel array 400 includes color filters in a pattern other than the Bayer pattern, the plurality of image pixels 460, 470 and 480 included in the image data 450 may also have a color arrangement according to the pattern of the color filters included in the pixel array 400.

The image processing device of some example embodiments may convert the image data 450 into source data in a YUV format. The plurality of respective source pixel data included in the source data may correspond to the plurality of image pixels 460, 470 and 480 of some example embodiments illustrated in FIG. 6. A plurality of image pixels 460, 470 and 480 may correspond to coordinates along the first direction and the second direction, and the coordinates may include a first coordinate value along the first direction and a second coordinate value along the second direction.

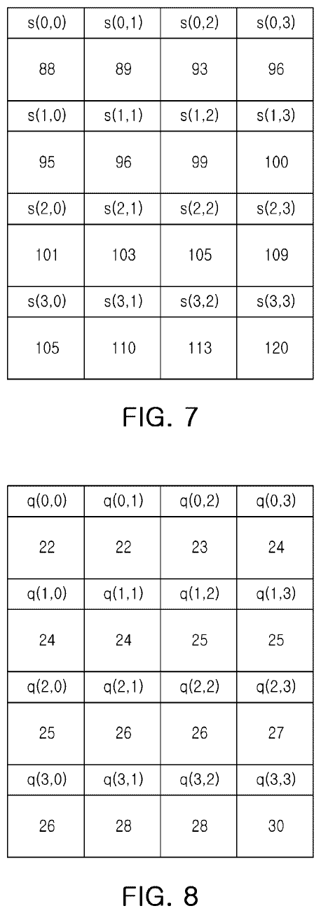

FIG. 7 is a diagram illustrating source data according to some example embodiments. FIG. 8 is a diagram illustrating quantized data according to some example embodiments.

First, referring to FIG. 7, the source data may include a plurality of source pixel data. As some example embodiments illustrated in FIG. 7, the source data may include a plurality of source pixel data s(0,0) to s(3,3) having four rows and four columns. The coordinates of the plurality of source pixel data s(0,0) to s(3,3) may correspond to the respective coordinates of the plurality of image pixels.

Each of the plurality of source pixel data s(0,0) to s(3,3) may have a value, and the value may be expressed in a binary format. In some example embodiments, the plurality of source pixel data s(0,0) to s(3,3) may have a value between 0 and 255, and the value may be expressed in a 9-bit binary format. When the source data is in YUV format, the source pixel data may represent at least one of luminance and chrominance. However, the present inventive concepts are not be limited thereto.

The frame buffer compressor of some example embodiments may perform quantization on the source data using a plurality of pixel position offsets corresponding to the respective coordinates of the plurality of image pixels, and a predetermined quantization coefficient, to generate quantized data. The quantized data may include a plurality of quantized pixel data corresponding to the plurality of respective image pixels. In detail, quantization may be performed in units of coordinates corresponding to the plurality of image pixels.

The frame buffer compressor of some example embodiments may generate quantized pixel data by calculating source pixel data, a quantization offset determined by ½ of a quantization coefficient, a pixel position offset, and a quantization coefficient. The quantization coefficient may be a reference interval that divides the size of the source pixel data into a certain interval. For example, the quantization coefficient may be a positive even number, and the quantization offset may be ½ of the quantization coefficient.

The quantized pixel data may satisfy mathematical expression 1. In detail, the quantized pixel data QPD may be calculated by dividing the result of adding a quantization offset QOFF to the source pixel data SPD and subtracting a pixel position offset POFF by the quantization coefficient QS.

$$Q P D = \frac{S P D + Q O F F - P O F F}{Q S} \qquad [ Mathematical Expression 1 ]$$

The pixel position offset PDFF may be calculated using the coordinates of the image pixel. Referring to FIG. 6, the coordinates of the image pixel may include a first coordinate value along a first direction and a second coordinate value along a second direction. The frame buffer compressor may calculate the corresponding pixel position offset by modulo-operating the first coordinate value and the second coordinate value.

In some example embodiments, the frame buffer compressor may calculate the pixel position offset by modulo-2-operating the sum of the first coordinate value and the second coordinate value. By performing the modulo-2 operation, the pixel position offset may be zero (0) or one (1). A modulo operation may be dividing the number by the modulo-“number” (e.g., modulo-2, modulo-4) and keeping the remainder as the result. For example, in a modulo-2 operation of three, the three divided by two would have a remainder of one, and the result would be one. For example, in a modulo-4 operation of three, the three divided by four would have a remainder of three, and the result would be three.

Referring to FIG. 8, the quantized data generated by applying quantization coefficient 4 to the source data of the example embodiment illustrated in FIG. 7 may be illustrated. The quantized data may include a plurality of quantized pixel data q(0,0) to q(3,3) having four rows and four columns. Each of the plurality of source pixel data q(0,0) to q(3,3) may correspond to respective coordinates of the plurality of image pixels and the plurality of source pixel data s(0,0) to s(3,3).

Referring to (0,0) of FIGS. 7 and 8, the pixel position offset calculated by modulo-2 operation of the sum of the first coordinate value (0) and the second coordinate value (0) is 0. As a result of adding the quantization offset 4/2=2 to the source pixel data s(0,0)=88 and subtracting the pixel position offset (0) and dividing the result by the quantization coefficient 4, the quantized pixel data q(0,0) may be calculated as 22.

Referring to (0,1) of FIGS. 7 and 8, the pixel position offset calculated by modulo-2 operation of the sum of the first coordinate value (0) and the second coordinate value (1) is 1. As the result of adding the quantization offset 4/2=2 to the source pixel data s(0,1)=89 and subtracting the pixel position offset 1 therefrom and dividing the result by the quantization coefficient 4, the quantized pixel data q(0,1) may be calculated as 22.

Referring to (0,2) of FIG. 7 and FIG. 8, the pixel position offset calculated by modulo-2 operation of the sum of the first coordinate value (0) and the second coordinate value 2 is 0. As the result of adding the quantization offset 4/2=2 to the source pixel data s(0,2)=93 and subtracting the pixel position offset (0) and dividing the result by the quantization coefficient 4, the quantized pixel data q(0,2) may be calculated as 23.

Referring to (0,3) of FIG. 7 and FIG. 8, the pixel position offset calculated by performing modulo-2 operation on the sum of the first coordinate value (0) and the second coordinate value (3) is 1. As a result of adding the quantization offset 4/2=2 to the source pixel data s(0,3)=96 and subtracting the pixel position offset 1 and dividing the result by the quantization coefficient 4, the quantized pixel data q(0,3) may be calculated as 24.

The remaining quantized pixel data q(1,0) to q(3,3) may also be calculated and obtained in the same manner as above.

In some example embodiments, the method of calculating the pixel position offset may be set so that the pixel position offset is calculated as 0 or 1. The pixel position offset may be calculated by performing modulo-2 operation on the sum of the first coordinate value, the second coordinate value, and 1. The pixel position offset may be calculated by performing a modulo-2 operation on the first coordinate value or by performing a modulo-2 operation on the second coordinate value. The pixel position offset may be calculated by performing a modulo-2 operation on the product of the first coordinate value and the second coordinate value.

Alternatively, the pixel position offset may be calculated by performing an exclusive OR (XOR) operation on the result of performing a modulo-4 operation on the first coordinate value and the result of performing a modulo-4 operation on the second coordinate value, and performing a modulo-2 operation on the result of the exclusive OR operation. However, the method for calculating the pixel position offset may not be limited thereto.

In some example embodiments, the above processes of calculating the pixel position offset using the coordinates of the image pixels and reflecting the pixel position offset in the quantized data may be equally applied to the filtering process of the source data. For example, when performing spatial domain filtering, the methods for calculating the pixel position offset described above may be applied to calculate the first offset.

A first offset may be determined, which is determined by a predetermined coefficient and a second offset that is determined by ½ of the predetermined coefficient. According to the mathematical expression 1, the source data may be filtered using the first offset, the second offset, and the predetermined coefficient.

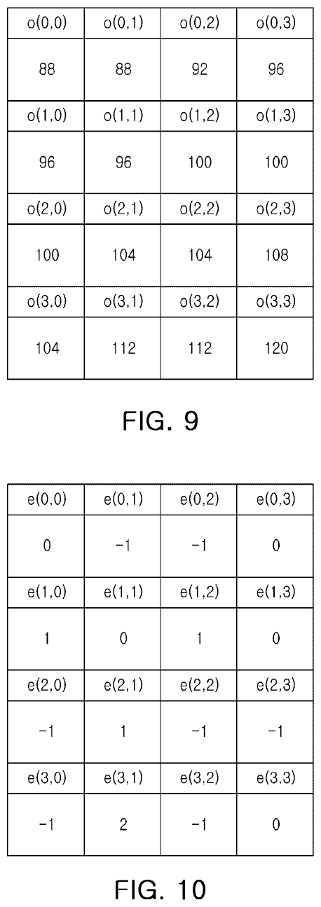

FIG. 9 is a diagram illustrating output data according to some example embodiments.

The frame buffer compressor may generate output data from recon data. The recon data may be data generated by compressed data passing through a mode selector, an unpadding module, an entropy encoding module, and a prediction compensation module. The recon data may include a plurality of recon pixel data, and coordinates of the plurality of recon pixel data may correspond to respective coordinates of the plurality of image pixels. For example, the recon data may be the same as the quantized data. In detail, the recon pixel data and the quantized pixel data corresponding to the same coordinate may be the same.

The frame buffer compressor may generate output data by decompressing the recon data. The frame buffer compressor may generate output data by reflecting a predetermined quantization coefficient to the quantized data. For example, the output data may be a product of the recon data and the quantization coefficient. The output data may include a plurality of output pixel data o(0,0) to o(3,3).

The output pixel data may satisfy mathematical expression 2. In detail, the output pixel data OPD may be obtained by multiplying the recon pixel data RPD by the quantization coefficient QS. Hereinafter, also referring to FIG. 8, the output pixel data when the quantization coefficient is 4 will be described.

$$O P D = R P D \times Q S \qquad [ Mathematical Expression 2 ]$$

Referring to (0,0) of FIGS. 7 and 8, as a result of multiplying the recon pixel data 22 by the quantization coefficient 4, the output pixel data o(0,0) may be calculated as 88. Referring to (0,1) of FIGS. 7 and 8, as a result of multiplying the recon pixel data 22 by the quantization coefficient 4, the output pixel data o(0,1) may be calculated as 88.

Referring to (0,2) of FIGS. 7 and 8, as a result of multiplying the recon pixel data 23 by the quantization coefficient 4, the output pixel data o(0,3) may be calculated as 92. Referring to (0,3) of FIGS. 7 and 8, as a result of multiplying the recon pixel data 24 by the quantization coefficient 4, the output pixel data o(0,3) may be calculated as 96.

The remaining output pixel data o(1,0) to o(3,3) may also be calculated and obtained in the same manner as above.

FIG. 10 is a diagram illustrating error data according to some example embodiments.

Referring to FIGS. 7 to 9 together, the method of producing quantized data by performing quantization on source data may not correspond to the method of producing output data by performing inverse quantization on recon data. In detail, mathematical expression 1 used for quantization and mathematical expression 2 used for inverse quantization may not be symmetrical.

In the quantization process, lossy compression may be performed by applying quantization coefficient and pixel position offset to the source data. In the inverse quantization process, lost data cannot be restored, so a difference may occur between the output data and the source data.

Referring to FIG. 10, the error data may include a plurality of error pixel data e(0,0) to e(3,3). The plurality of respective error pixel data e(0,0) to e(3,3) may correspond to the respective coordinates of the plurality of image pixels and the plurality of source pixel data s(0,0) to s(3,3). The error pixel data may be the difference between the output pixel data and the source pixel data.

Referring to (0,0) of FIGS. 7 to 10, as a result of subtracting the source pixel data 89 from the output pixel data 88, the error pixel data e(0,0) may be calculated as 0. Referring to (0,1) of FIGS. 7 to 10, as a result of subtracting the source pixel data 89 from the output pixel data 88, the error pixel data e(0,0) may be calculated as −1.

Referring to (0,2) of FIGS. 7 to 10, as a result of subtracting the source pixel data 93 from the output pixel data 92, the error pixel data e(0,2) may be calculated as −1. Referring to (0,3) of FIGS. 7 to 10, as a result of subtracting the source pixel data 96 from the output pixel data 96, the error pixel data e(0,3) may be calculated as 0.

The remaining output pixel data o(1,0) to o(3,3) may also be calculated and calculated in the same manner as above.

The error pixel data according to some example embodiments may not be biased in a specific direction and may have a random tendency. In some example embodiments illustrated in FIG. 10, the error pixel data may have a value between −1 and 2. Since the error pixel data are not composed of only 0 and positive values, or only 0 and negative values, the sum of the plurality of error pixel data may converge to 0.

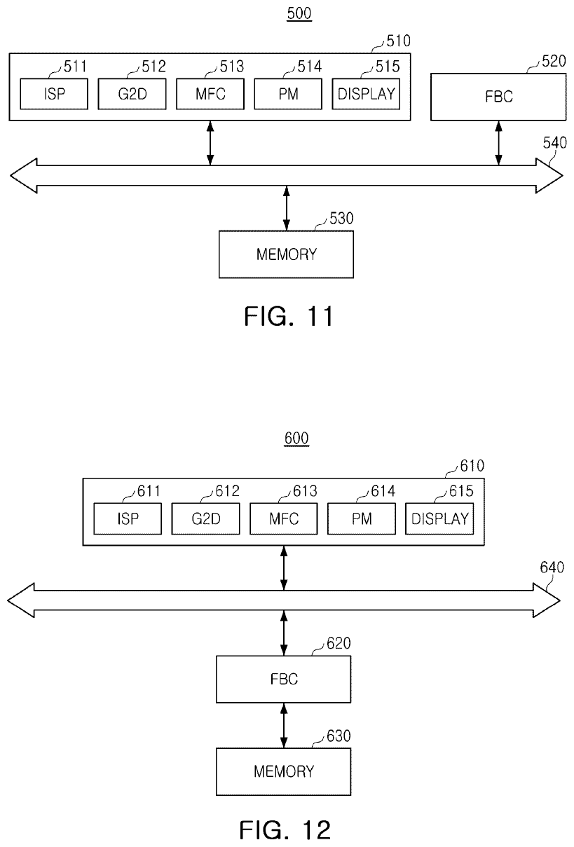

FIG. 11 is a block diagram illustrating an image processing device according to some example embodiments.

FIG. 11 is a block diagram for explaining an image processing device 500 according to some example embodiments. Specific embodiments of the image processing device may be similar to those described above in FIGS. 1 to 10. Hereinafter, differences will be mainly described.

Referring to FIG. 11, the multimedia IP 510, the frame buffer compressor 520, and the memory 530 may each be directly connected to the system bus 544. The frame buffer compressor 520 is not directly connected to the multimedia IP 510, but may be connected to each other through the system bus 540.

The multimedia IP 510 may transmit data to the frame buffer compressor 520 through the system bus 540. During the compression process, the multimedia IP 510 may transmit source data to the frame buffer compressor 520 through the system bus 540. The frame buffer compressor 520 may generate compressed data from source data and transmit the compressed data back to the memory 530 through the system bus 540.

In addition, during the decompression process, the frame buffer compressor 520 may receive the compressed data stored in the memory 530 through the system bus 540. The frame buffer compressor 520 may decompress the received compressed data into output data. The frame buffer compressor 520 may transmit the output data to the multimedia IP 510 through the system bus 540.

In some example embodiments illustrated in FIG. 11, the frame buffer compressor 520 may be connected to the image signal processor 511, the shake correction module 512, the multi-format codec 513, the processing module 514, and the display 515 of the multimedia IP 510 through the system bus 540 without being individually connected. Therefore, the hardware configuration may be simplified and the operating speed may be improved.

FIG. 12 is a block diagram illustrating an image processing device according to some example embodiments.

FIG. 12 is a block diagram for explaining an image processing device 600 according to some example embodiments. Specific embodiments of the image processing device may be similar to those described above in FIGS. 1 to 10. Hereinafter, the differences will be described.

Referring to FIG. 12, the multimedia IP 610 and the frame buffer compressor 620 may be directly connected to the system bus 640. The memory 630 may be connected to the system bus 640 through the frame buffer compressor 620. In detail, the memory 630 is not directly connected to the system bus 640, and may be connected to the system bus 440 only through the frame buffer compressor 620.

In addition, the image signal processor 611, the shake correction module 612, the multi-format codec 613, the processing module 614, and the display 615 of the multimedia IP 610 may be directly connected to the system bus 640. The image signal processor 611, the shake correction module 612, the multi-format codec 613, the processing module 614, and the display 615 of the multimedia IP 610 may access the memory 630 only through the frame buffer compressor 620.

In some example embodiments illustrated in FIG. 12, all accesses to the memory 630 may involve the frame buffer compressor 620. By directly connecting the frame buffer compressor 620 to the system bus 640 and connecting the memory 630 to the system bus 640 through the frame buffer compressor 620, errors in data transmission may be reduced and speeds may be improved.

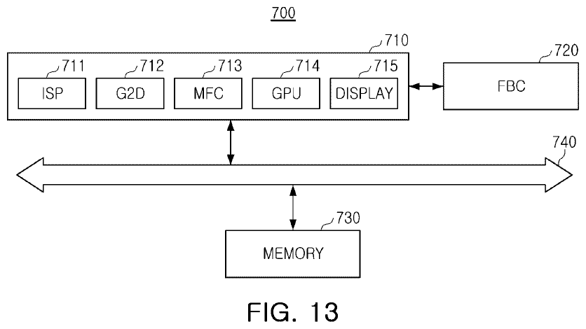

FIG. 13 is a drawing simply illustrating an image processing device according to some example embodiments.

FIG. 13 is a block diagram for explaining an image processing device 700 according to some example embodiments. Specific embodiments of the image processing device may be similar to those described above in FIGS. 1 to 10. Hereinafter, differences will be mainly described.

Referring to FIG. 13, a system bus 740 may be directly connected to a multimedia IP 710 and a memory 730. A frame buffer compressor 720 may be connected to a multimedia IP 710. A frame buffer compressor 720 may receive source data from a multimedia IP 710. A frame buffer compressor 720 may compress the source data to generate compressed data, and may then transmit the compressed data to a multimedia IP 710. A multimedia IP 710 may store the compressed data in a memory 730 through a system bus 740.

During the decompression process, the multimedia IP 710 may receive compressed data from the memory 730 through the system bus 740. The multimedia IP 710 may transfer the compressed data to the frame buffer compressor 720. The frame buffer compressor 720 may decompress the compressed data to generate output data and transfer the output data back to the multimedia IP 710.

As set forth above, according to some example embodiments, a frame buffer compressor may calculate a pixel position offset corresponding to coordinates of each of a plurality of image pixels included in source data, and apply the pixel position offset to a process of quantizing the source data. Accordingly, errors occurring in data compression and decompression processes may be prevented or have a reduced effect thereof from being biased in a specific direction.

For example, according to some example embodiments, there may be an increase in reliability, operating parameters, speed, accuracy, and/or power efficiency of the device based on the above methods. Therefore, the improved devices and methods overcome the deficiencies of the conventional devices and methods while reducing resource consumption, and/or improving data accuracy, operating parameters, and resource allocation (e.g., latency). Further, there is an improvement in user experience in the device by providing the improved process. As such, there may be an improvement in processing source data of a pixel array.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While some example embodiments have been illustrated and described above, it will be apparent to those skilled in the art that modifications and variations could be made without departing from the scope of the present inventive concepts as defined by the appended claims.

What is claimed is:

1. An image processing device comprising:
a multimedia Intellectual Property configured to
process image data and
generate source data; and
a frame buffer compressor configured to
compress the source data,
generate compressed data,
decompress the compressed data, and
generate output data,
generate quantized data by performing quantization on the source data using a plurality of pixel position offsets corresponding to each of coordinates of a plurality of image pixels included in the source data, a quantization coefficient, and a quantization offset determined as ½ of the quantization coefficient, and
generate the compressed data by processing the quantized data.

2. The image processing device of claim 1, wherein the quantization coefficient is a positive even number.

3. The image processing device of claim 1, wherein each of the plurality of pixel position offsets is 0 or 1.

4. The image processing device of claim 3, wherein each of the coordinates of the plurality of image pixels includes a first coordinate value along a first direction, and a second coordinate value along a second direction intersecting the first direction.

5. The image processing device of claim 4, wherein the frame buffer compressor is configured to calculate each of the plurality of pixel position offsets by modulo-operating the first coordinate value and the second coordinate value for each of the plurality of image pixels.

6. The image processing device of claim 5, wherein the frame buffer compressor is configured to calculate each of the plurality of pixel position offsets by modulo-2-operating a sum of the first coordinate value and the second coordinate value for each of the plurality of image pixels.

7. The image processing device of claim 5, wherein the frame buffer compressor is configured to calculate each of the plurality of pixel position offsets by performing a modulo-2 operation on a sum of the first coordinate value, the second coordinate value, and 1 for each of the plurality of image pixels.

8. The image processing device of claim 5, wherein the frame buffer compressor is configured to calculate each of the plurality of pixel position offsets by performing a modulo-2 operation on the first coordinate value for each of the plurality of image pixels.

9. The image processing device of claim 5, wherein the frame buffer compressor is configured to calculate each of the plurality of pixel position offsets by performing a modulo-2 operation on the second coordinate value for each of the plurality of image pixels.

10. The image processing device of claim 5, wherein the frame buffer compressor is configured to calculate each of the plurality of pixel position offsets by performing a modulo-2 operation on a product of the first coordinate value and the second coordinate value for each of the plurality of image pixels.

11. The image processing device of claim 5, wherein the frame buffer compressor is configured to calculate each of the plurality of pixel position offsets by performing an exclusive OR (XOR) operation on a result of modulo-4 operation of the first coordinate value and a result of modulo-4 operation of the second coordinate value, for each of the plurality of image pixels, and by performing a modulo-2 operation on a result of the exclusive OR operation.

12. The image processing device of claim 1, wherein
the source data includes a plurality of source pixel data respectively corresponding to the plurality of image pixels, and the quantized data includes a plurality of quantized pixel data respectively corresponding to the plurality of image pixels, and
the frame buffer compressor is configured to generate the quantized pixel data by calculating the source pixel data, the quantization offset, a respective one of the plurality of pixel position offsets, and the quantization coefficient for each of the plurality of image pixels.

13. The image processing device of claim 12, wherein the frame buffer compressor is configured to generate the quantized pixel data by obtaining a result of adding the quantization offset to the source pixel data and subtracting a respective one of the plurality of pixel position offsets and dividing the obtained result by the quantization coefficient.

14. The image processing device of claim 1, further comprising:
a sensor configured to generate the image data; and
a memory configured to store the compressed data and configured to output the compressed data.

15. A frame buffer compressor comprising:
an encoder configured to compress source data and generate compressed data; and
a decoder configured to decompress the compressed data and generate output data,
the encoder is further configured to
generate quantized data by performing quantization on the source data using pixel position offsets obtained by modulo operating each of coordinates of a plurality of image pixels included in the source data, and a quantization coefficient, and
generate the compressed data by processing the quantized data.

16. The frame buffer compressor of claim 15, wherein each of the pixel position offsets is 0 or 1.

17. The frame buffer compressor of claim 15, wherein the decoder is configured to generate the output data using the compressed data and the quantization coefficient.

18. The frame buffer compressor of claim 17, wherein the decoder is configured to generate the output data as a product of recon data generated by processing the compressed data and the quantization coefficient.

19. A data processing method comprising:
receiving source data from a multimedia Intellectual Property;
calculating a first offset determined by each of coordinates of a plurality of image pixels included in the source data by a frame buffer compressor;
determining a second offset based on a coefficient and ½ of the coefficient by the frame buffer compressor; and
performing, by the frame buffer compressor, an operation of obtaining a result of subtracting the first offset from the source data and adding the second offset and dividing the obtained result by the coefficient.

20. The data processing method of claim 19, wherein the calculating the first offset includes calculating the first offset by performing a modulo-2 operation on a sum of a first coordinate value and a second coordinate value for each of the plurality of image pixels.
